(19) United States
(12) Patent Application Publication
(10) Pub. No.: US 2024/0229512 A9
(43) Pub. Date: Jul. 11, 2024

(54) APPARATUS FOR LATCHING AN APPLIANCE DOOR

(71) Applicant: Thermo Electron LED GmbH, Osterode am Harz (DE)

(72) Inventors: Daniel RADTKE, Osterode am Harz (DE); Daniel LANGER, Osterode am Harz (DE)

(73) Assignee: Thermo Electron LED GmbH, Osterode am Harz (DE)

(21) Appl. No.: 18/493,736

(22) Filed: Oct. 24, 2023

(30) Foreign Application Priority Data
Oct. 25, 2022 (EP) 22203659.2

(51) Int. Cl. E05B 47/00; B04B 7/06

(52) U.S. Cl. CPC E05B 47/0012; B04B 7/06; E05B 2047/0069

(57) ABSTRACT

The present invention relates to the latching closed of doors on appliances. In particular, the present invention provides an advantageous apparatus for locking the lid of a centrifuge. Apparatus for locking an appliance door in a closed position, the apparatus comprises: a locking member for attachment to a door, the locking member having an engagement section; a locking bolt for engaging the engagement section in the locking member; a linear actuator for moving the locking bolt along an axis, wherein the linear actuator is self-locking.

### FIELD

The disclosure pertains to the latching closed of doors on appliances. In particular, the present disclosure provides an advantageous apparatus for locking the lid of a centrifuge.

### BACKGROUND

It is known to provide latches on doors of appliances. It is particularly important for appliances that carry heavy loads or move loads at high speeds that the latch should be robust to impacts from the contents of the appliances. By way of example, a laboratory centrifuge spins samples at extremely high speeds. In the event of a failure of the rotor or load in such a device, the kinetic energy of broken components can be very high. As such, there is an increased need for safety in such systems. Conventional latches may not be sufficient to withstand such impacts.

### SUMMARY

Apparatus for locking an appliance door in a closed position, the apparatus comprising: a locking member for attachment to a door, the locking member having an engagement section; a locking bolt for engaging the engagement section in the locking member; a linear actuator for moving the locking bolt along an axis, wherein the linear actuator is self-locking.

### BRIEF DESCRIPTION OF THE DRAWINGS

For a better understanding of the invention, and to show how the same may be put into effect, reference will now be made, by way of example only, to the accompanying drawings in which:

FIG. 1A shows a cross-sectional view of apparatus for latching an appliance door;

FIG. 1B shows an exploded view of the apparatus of FIG. 1A;

FIG. 2 shows an appliance comprising the apparatus of FIGS. 1A-1B; and

FIG. 3 shows a close-up view of a preferred locking bolt.

### DETAILED DESCRIPTION

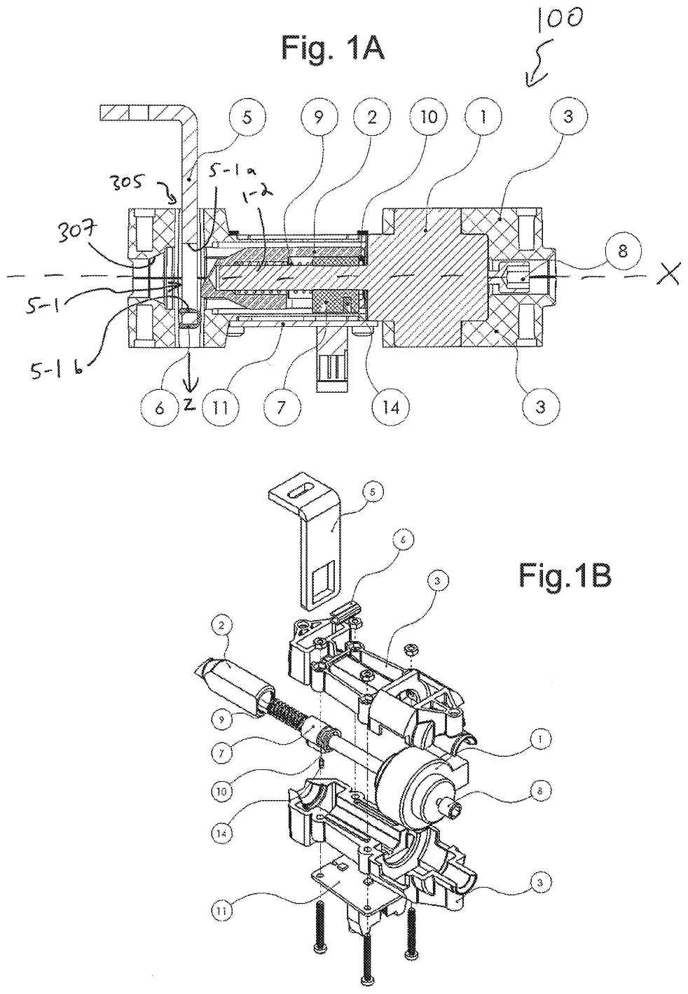

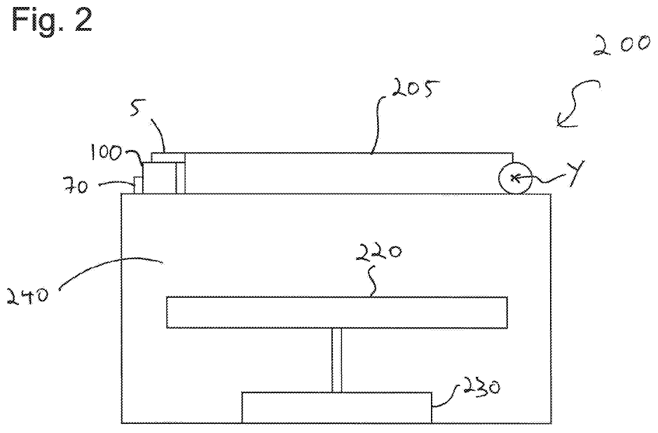

FIGS. 1A-1B show a first embodiment of an apparatus 100 for locking a door 205 of an appliance 200 such as that shown in FIG. 2.

The apparatus 100 comprises a locking member 5; and a locking bolt 2 for engaging the locking member 5. When the locking bolt 2 engages the locking member 5, the door 205 is prevented from opening.

The apparatus 100 comprises a linear actuator 1, 7 for moving the locking bolt 2 along an axis.

The linear actuator 1, 7 comprises an actuator 1 with a shaft 1-2 and a slider 7. Activating the actuator 1 moves the slider 7 up or down the longitudinal axis X of the shaft 1-2, thereby providing linear motion.

The linear actuator 1,7 may be arranged to drive the locking bolt 2 via a resilient member 9. Preferably, however, locking bolt 2 may be configured with a cavity for receiving the resilient member 9 (2-12 below) when compressed to enable the slider 7 to abut (that is, directly contact) the locking bolt 2.

A controller 70 may be provided to control the linear actuator 1, 7. One or more sensor(s) 14 in communication with the controller 70 may be provided to monitor the configuration of the actuator 1, 7. For example, a sensor 14 may indicate the linear position of the slider 7 along the shaft 1-2.

There are many ways in which the system may be implemented. However, it is envisaged that an input device (e.g., a button) may be provided for a user to instruct controller 70 to open the door. A sensor on the door 205 or locking member 5 would be used for signalling to the controller 70 that the door 205 is closed. The apparatus 100 can preferably thereby lock automatically upon closing the door 205, and unlock in response to a user input. Alternatively, the apparatus 100 can unlock in response to a signal indicating that a process carried out by the appliance 200 has been completed.

In a preferred linear actuator 1, 7 the actuator may include a motor 1 having a threaded shaft 1-2 on which is mounted a slider 7 in the form of a threaded nut 7. In this case, activation of the motor 1 rotates the threaded shaft 1-2. The nut is prevented from rotating with the shaft 1-2 so that rotation of the shaft 1-2 drives the nut 7 to move via engagement of the threads of the shaft 1-2 and nut 7.

Irrespective of its particular form, the linear actuator 1, 7 is not back-drivable. In other words, it is a self-locking actuator. As such, activation of the actuator 1 produces linear motion of the slider 7, but when the actuator 1 is not activated, any force applied to the slider 7 is reacted by the linear actuator to prevent movement of the slider 7.

In the example of the linear actuator 1, 7 formed from a motor 1, threaded shaft 1-2, and nut 7 threadingly mounted on the shaft (1-7), back-driving can be prevented by the selection of the pitch of the thread. As is known in the field of gearing, it is possible to select a pitch such that when an axial force is applied to the nut 7, the friction between the nut 7 and the threaded shaft 1-2 increases at a greater rate than the resolved rotational force applied to the threaded shaft 1-2. The friction thus prevents axial force on the nut 7 from rotating the shaft 1-2. As such, it is not back-drivable.

When installed in an appliance 200, such as a centrifuge, the apparatus 100 is arranged to lock the door 205 of the appliance in a closed position. Locking member 5 may be attached to, or part of, the door 205 of the appliance, such that restraining locking member 5 in a fixed position prevents the door 205 from opening. For example, the door 205 may be hinged, with locking member 5 offset from the hinge axis Y. In another example, the door may be separable from the rest of the appliance, with multiple locking members 5 spaced around its periphery.

The apparatus 100 preferably comprises a housing 3 having an opening 305 for receiving the locking member 5. The locking member 5 may be inserted through the opening 305 in an insertion direction Z or withdrawn from the opening 305 in a withdrawal direction, opposite the insertion direction Z. The housing 3 may form part of, or be fastened to, a housing or structure of the appliance 200.

Although not limiting, as depicted, locking member 5 is an arm with an engagement section 5-1 for receiving a locking bolt 2. As depicted, the engagement section 5-1 is an aperture in the locking member 5. In alternative embodiments, the engagement section 5-1 may be a hook-shaped part of the locking member 5, or could be a narrowed section of the locking member 5. The engagement section 5-1 of any of these examples is arranged to abut with the locking bolt 2 in the withdrawal direction to prevent further withdrawal of the locking member 5, and is arranged to abut with the locking bolt 2 in the insertion direction Z to prevent further insertion of the locking member 5. The engagement section 5-1 may therefore comprise an insertion stop 5-1a for abutting the locking bolt 2 in the insertion direction Z and a withdrawal stop 5-1b for abutting the locking bolt 2 in the withdrawal direction.

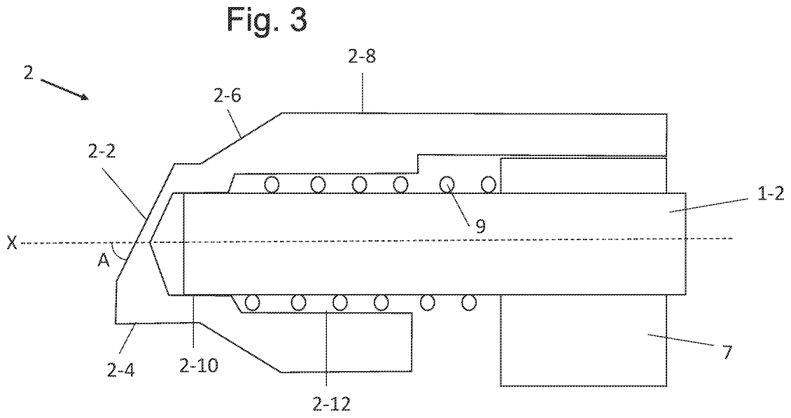

FIG. 3 shows a close-up view of a preferred locking bolt 2. The locking bolt 2 may be slidably mounted on the shaft 1-2 such that it can freely slide axially (i.e. it is not engaged with a thread of the shaft 1-2). A resilient member 9 such as a spring (as shown) may be provided, for example, around the shaft 1-2, to bias the locking bolt 2 to a location a predetermined distance from the nut 7 along the shaft 1-2. For example, a first end of the resilient member 9 may abut the locking bolt 2 and a second end of the resilient member 9 may abut the nut 7. The resilient member 9 has a maximum length in an uncompressed state.

The resilient member 9 may be a spring or other elastic material component arranged to bias the locking bolt 2 relative to the slider 7 by its tension or compression, or may be some other mechanism arranged to provide to bias the locking bolt 2 to a location a predetermined distance from the nut 7 along the shaft 1-2.

As can be seen, the locking bolt 2 may include a nose portion 2-2, 2-4 at the tip of the locking bolt 2; a tapered portion 2-6; and a wide portion 2-8 separated from the nose portion 2-2, 2-4 by the tapered portion 2-6.

The locking bolt 2 may have one or more bores 2-10, 2-12. As shown, a first bore 2-10 is used to slidably mount the locking bolt 2 onto the shaft 1-2. A larger second bore 2-12 may accommodate the resilient member 9, which in this example is a coil spring surrounding the shaft 1-2 and bearing against the end of the second bore 2-12.

The nose portion 2-2, 2-4 has a sloped surface 2-2 on a first side, and a latch surface 2-4, on a second side opposite the first side. The locking bolt 2 is arranged in the housing 3 such that the sloped surface 2-2 faces the opening 305 and the latch surface 2-4 faces away from the opening.

The sloped surface 2-2 is sloped relative to the axis X of the shaft 1-2, such that a force applied to the sloped surface 2-2 by the locking member 5 on insertion through the opening 305 can cause the locking bolt 2 to move and thereby compress the resilient member 9. In this way, closing the door 205 of the appliance inserts locking member 5 into the opening 305 and presses the locking member 5 against the sloped surface 2-2 to move the lock bolt 2 out of the way and enable full insertion of the locking member 5 into the housing 3. The slope angle of sloped surface 2-2 should be large enough that the closing force required of the user is not too great. If the slope angle is too large, the displacement of the lock bolt 2 would not cause sufficient compression of the resilient member 9. Preferably, sloped surface 2-2 would have a slope angle, A, relative to the longitudinal axis of the shaft 1-2, of 15 to 80 degrees. In preferable embodiments, sloped surface 2-2 would have a slope angle of at least 45 degrees. More preferably, sloped surface 2-2 would have a slope angle of no more than 70 degrees.

In preferred embodiments, the locking member 5 comprises a low friction material (the low-friction material has a lower coefficient of friction than the remainder of the material of the locking member 5) bordering at least part of the engagement section 5-1. Preferably, the low friction material is provided on the most distal part of the locking member 5-1 in the insertion direction Z (i.e., the surface that contacts the sloped surface 2-2).

When the engagement section 5-1 of the locking member 5 aligns with the end of the locking bolt 2, the resilient member 9 is free to extend again, and so the locking bolt 2 can slide into the engagement section 5-1 such that the latch surface 2-4 is aligned with the engagement section 5-1. In this position, the latch surface 2-4 prevents the locking member 5 from being withdrawn. In contrast to the sloped surface 2-2, force applied to the latch surface 2-4 by the locking member 5 does not cause the locking bolt 2 to compress the resilient member 9. For example, the latch surface 2-4 may extend parallel, or substantially parallel, to the axis X of the shaft 1-2. In other examples, the latch surface 2-4 could define a seat (for example, a self-centering seat) arranged such that any force applied to the latch surface 2-4 prevents movement of the locking bolt 2 away from alignment with the locking member 5.

In this manner, the resilient member 9 and locking member 2 work together as a latch, to enable the door 205 to be closed and latched shut.

Preferably, the height of the nose portion 2-2, 2-4 (the maximum distance between the sloped surface 2-2 and the latch surface 2-4 in the insertion direction Z) is less than the height of the engagement section 5-1 (the maximum opening in the insertion direction Z).

Firmer locking of the door 205 can be achieved by actuation of the linear actuator 1, 7, to extend the locking member 2 further through the engagement section 5-1. As the locking member 2 is inserted further into the engagement section 5-1, the tapered portion 2-6 can align the engagement section 5-1 with the locking bolt 2. That is, if the locking member 5 is not fully inserted, or is inserted beyond an aligned position, the tapered portion 2-6 can align the engagement section 5-1. Once the locking bolt 2 has been extended beyond the tapered portion 2-6 through the engagement section 5-1, the wide portion 2-8 of the locking bolt 2 is aligned within the engagement section 5-1. The wide portion 2-8 may have a height that equals, or substantially matches, the height of the engagement section 5-1. In this way, movement of the locking member 5 can be prevented or limited.

In preferred embodiments, a seat 307 is provided in the housing 3 for engagement with the locking bolt 2. The seat 307 is located such that it is on the opposite side of the locking member 5 to the linear actuator 1, 7, when the locking member 5 is fully inserted through the opening 305. For example, the seat 307 may have a shape that is complementary to the tapered portion 2-6 to provide centering of the locking bolt 2 ensuring the stability of the locking bolt 2 when the door 205 is locked.

In this way, the locking bolt 2 comprises a narrower latching portion and a thicker locking portion. When the latching portion is aligned with the opening 305, the door 205 may be closed by the locking member 5 contacting the latching portion and forcing the locking bolt 2 to retract until it is free to insert into the engagement section 5-1, such that the locking member 5 is loosely held in position with a first amount of play. When the locking portion is aligned with the opening 305, while the locking member 5 is inserted therein with the locking bolt 2 extending therethrough, the locking member 5 is closely held in position with a second amount of play, the second amount of play being less than the first amount of play. Play in this context means the amount of free movement of the locking member 5 relative to the locking bolt 2 in the insertion and withdrawal directions.

The linear actuator 1, 7 is arranged to retract the locking member 2 such that the locking member 5 can move into and out of the opening 305 without engaging the locking bolt 2.

Thus, there are three positions in the axial direction of the shaft 1-2 for the locking member 2, a retracted position, a latching position, and a locked position.

In the retracted position, the locking bolt 2 is retracted so as not to be aligned with the opening 305 so that it cannot be engaged by the locking member 5.

In the latching position, the locking bolt 2 is located with the sloped portion 2-2 and latching portion 2-4 aligned with the opening 305, with the resilient member 9 in an extended state. In this latching position, insertion of the locking member 5 into the opening 305 will cause the locking member 5 to contact the sloped surface 2-2. This will move the locking bolt 2 towards the retracted position, compressing resilient member 9 until the engagement section 5-1 aligns with the locking member 2, allowing the locking bolt 2 to return to the latching position. When the locking bolt 2 returns to the latching position within the engagement section 5-1, the latch surface 2-4 will prevent the locking member 5 from being removed from the opening 305.

In the locked position, the wide portion 2-8 is aligned with the opening 305. When the locking bolt 2 is in the locked position within the engagement section 5-1, it closely fits the engagement section 5-1 so as to prevent or limit movement of the locking member 5.

The three positions of the locking member correspond to three positions of the nut 7.

When the locking bolt 2 is in the retracted position, the nut 7 is in a first position on the shaft 1-2, and the resilient member 9 is uncompressed (or, in some arrangements, unstretched).

When the locking bolt 2 is in the latching position, the nut 7 is in a second position on the shaft 1-2, and the resilient member is uncompressed. However, the resilient member 9 may be compressed by insertion of the locking member 5 into the opening 305.

When the locking bolt 2 is in the locked position, the nut 7 is in a third position on the shaft 1-2. It is preferable, in this case, to prevent inadvertent movement of the door 205, that the resilient member 9 is compressed. Preferably, compression of resilient member 9 enables the nut 7 to abut the locking bolt 2. This can remove any possibility of play in the location of the locking bolt 2. In preferred embodiments, the shaft 1-2 may be manually rotatable (i.e., by a user) via an engagement member 8. The engagement member 8 may extend out of the housing 3, or an opening may be provided in the housing 3 for a tool to engage with the engagement member 8.

The apparatus 100 may be used in a method of closing a door 205 of an appliance 200 as described below.

When the door 205 is open, the controller 70, via linear actuator 1, 7 positions the locking bolt 2 such that the latching portion is aligned with the opening 305.

Preferably, the controller 70 moves the nut 7 of the linear actuator 1, 7 to the second position, such that the locking bolt 2 is biased into this alignment (the latching position) by the resilient member 9 that locates the locking bolt 2 relative to the nut 7.

The door 205 may be closed by a user. This inserts the locking member 5 into the opening 305.

The engagement of the locking member 5 with the latching portion forces the locking bolt 2 to retract against the bias of the resilient member 9.

The alignment of the engagement section 5-1 with the locking bolt 2 enables the resilient member 9 to extend the locking bolt 2 into the engagement section 5-1, such that the latching portion again aligns with the opening 305.

When the appliance 200 is activated, the linear actuator 1, 7 positions the locking bolt 2 such that the locking portion is aligned with the opening 305.

Preferably, the controller 70 moves the nut 7 of the linear actuator 1, 7 to the third position, such that the locking bolt 2 is extended further through the engagement section 5-1 to contact a seat 307 in the housing 3 (the locked position).

Preferably, resilient member 9 is compressed in the second predetermined location, so as to

When the appliance 200 has completed its activity, the apparatus 100 may be used in a method of opening the door 205 of the appliance 200 as described below.

The controller 70, via linear actuator 1, 7 retracts the locking bolt 2 such that is not aligned at all with the opening 305.

Preferably, the controller 70 moves the nut 7 of the linear actuator 1, 7 to the first position, such that the locking bolt 2 cannot obstruct the locking member 5 (the retracted position).

The controller 70 may move the nut 7 (more generally, the slider 7) from the first position to the second position when it senses the door 205 has been opened. In this way, the locking bolt 2 moves from the retracted position to the latching position.

The controller 70 may move the nut 7 (more generally, the slider 7) from the second position to the third position when it senses the door 205 has been closed. In this way, the locking bolt 2 moves from the latching position to the locked position.

The controller 70 may move the nut 7 (more generally, the slider 7) from the third position to the first position in response to a user input (for example, a button press) or in response to a signal indicating that a process carried out by the appliance 200 has been completed. In this way, the locking bolt 2 moves from the locked position to the retracted position.

A particularly advantageous appliance 200 for the above described apparatus 100 is a centrifuge, since the kinetic energy of the components therein can provide the risk of extreme opening forces in the event of a failure.

The appliance 200 may therefore comprise: a chamber 240; a rotor 220 in the chamber; a motor 230 for driving the rotor; a door 205 for accessing the chamber 240; and the apparatus 100 for locking the door 205 in a closed position thereby closing the chamber 240.

1. Apparatus for locking an appliance door in a closed position, the apparatus comprising:
a locking member for attachment to a door, the locking member having an engagement section;
a locking bolt for engaging the engagement section in the locking member; and
a linear actuator for moving the locking bolt along an axis,
wherein the linear actuator is self-locking.

2. The apparatus of claim 1, wherein a resilient member biases the locking bolt relative to the linear actuator.

3. The apparatus of claim 1, wherein:
the locking bolt comprises a latching portion and a locking portion;
the latching portion is arranged such that contact with the locking member creates a force from the locking member along the axis for displacing the locking bolt; and
the locking portion is arranged such that contact with the locking member does not create a force from the locking member along the axis for displacing the locking bolt.

4. The apparatus of claim 3, wherein:
the locking member is configured to be moved in an insertion direction (Z) opposite to a withdrawal direction;
the latching portion has a sloping surface; and
the sloping surface is arranged for contacting the locking member as it moves in the insertion direction (Z) to thereby provide a reaction force that tends to retract the locking bolt along the axis.

5. The apparatus of claim 4, wherein the sloping surface has a slope angle relative to the axis of from 15 to 80 degrees, preferably from 45 degrees to 70 degrees.

6. The apparatus of claim 4, wherein:
the latching portion has a latch surface opposite the sloping surface; and
the latch surface is arranged for contacting the locking member as it moves in the withdrawal direction to thereby provide a reaction force that does not tend to retract the locking bolt along the axis.

7. The apparatus of claim 4, wherein:
the latching portion has a larger dimension in the insertion direction (Z) than the locking portion.

8. The apparatus of claim 4, wherein the locking bolt comprises a tapered portion between the latching portion and the locking portion.

9. The apparatus of claim 1, further comprising a controller for controlling the linear actuator, a door sensor for sensing a position of the door, and an actuation sensor for sensing the position of the locking bolt or the actuator or both, the controller arranged to locate the locking bolt along the axis in each of a locking position, a latching position, and a retracted position based on the door sensor and actuation sensor.

10. The apparatus of claim 1, wherein:
the linear actuator comprises an actuator with a shaft and a slider; and
the locking bolt is resiliently biased a predetermined distance from the slider along the shaft.

11. The apparatus of claim 10, wherein the shaft is a threaded rod and the slider is a nut threadingly mounted on the shaft.

12. The apparatus of claim 11, wherein a pitch of each of the threads of the threaded rod and nut is selected for self-locking.

13. The apparatus of claim 10, further comprising a controller for controlling the actuator, the controller arranged to locate the slider along the axis in each of a locking position, a latching position, and a retracted position.

14. The apparatus of claim 9, wherein:
in the latching position, contact between the locking member and locking bolt creates a force from the locking member along the axis for displacing the locking bolt;
in the locking position, the locking bolt locks the locking member in a fixed position within the apparatus; and
in the retracted position, the locking member cannot contact the locking bolt.

15. The apparatus of claim 1, further comprising a housing, wherein:
the housing houses the linear actuator and the locking bolt;
the housing includes an opening for receiving the locking member; and
the housing includes a seat for engaging the locking bolt, the seat being located opposite to the linear actuator when the locking member is received in the opening.

16. The apparatus of claim 15, further comprising an engagement member, wherein:
the engagement member is accessible from outside the housing; and
the engagement member enables manual actuation of the linear actuator for disengaging the locking bolt from the locking member.

17. The apparatus of claim 2, wherein:
the locking bolt comprises a latching portion and a locking portion;
the latching portion is arranged such that contact with the locking member creates a force from the locking member along the axis for displacing the locking bolt; and
the locking portion is arranged such that contact with the locking member does not create a force from the locking member along the axis for displacing the locking bolt.

18. The apparatus of claim 5, wherein:
the latching portion has a latch surface opposite the sloping surface; and
the latch surface is arranged for contacting the locking member as it moves in the withdrawal direction to thereby provide a reaction force that does not tend to retract the locking bolt along the axis.

19. The apparatus of claim 3, further comprising a controller for controlling the linear actuator, a door sensor for sensing a position of the door, and an actuation sensor for sensing the position of the locking bolt or the actuator or both, the controller arranged to locate the locking bolt along the axis in each of a locking position, a latching position, and a retracted position based on the door sensor and actuation sensor.

20. The apparatus of claim 19, wherein:
the linear actuator comprises an actuator with a shaft and a slider; and
the locking bolt is resiliently biased a predetermined distance from the slider along the shaft.
